(19) United States
(12) Patent Application Publication
(10) Pub. No.: US 2007/0021008 A1
(43) Pub. Date: Jan. 25, 2007

(54) Connecting terminals of multi-specification card reading socket

(75) Inventor: Fu-Ching Wang, Taipei (TW)

Correspondence Address: BACON & THOMAS, PLLC, 625 SLATERS LANE, FOURTH FLOOR, ALEXANDRIA, VA, 22314, US

(73) Assignee: Northstar systems Corp., Taipei (TW)

(21) Appl. No.: 11/186,851

(22) Filed: Jul. 22, 2005

(51) Int. Cl. H01R 24/00

(52) U.S. Cl. 439/630

(57) ABSTRACT

The present invention is an improvement on connecting terminals of multi-specification card-reading socket. To facilitate manufacturing process, the structure of connecting terminals embedded in a card-reading socket, where the card-reading socket allows insertion of memory cards with different specifications, is improved. The said connecting terminals are formed terminal module from a raw material, where the terminal module includes multiple connecting terminals. Also, inside the said terminal module U-shaped slots and grooves are provided. The terminal module is embedded in a card-reading socket after bended and formed, and then cutting at grooves are performed, such that multiple connecting terminals are embedded in the card-reading socket on the same time.

### BACKGROUND OF THE INVENTION

1) Field of the Invention

The present invention is an improvement on connecting terminals of multi-specification card-reading socket. More specifically, the present invention improves the connecting terminals which are embedded in a card-reading socket that accepts memory cards with different specifications. In the present invention, the terminals are modualized through structural design, the multiple connecting terminals are thus integrated into one, and through one-time processing, multiple connecting terminals are accordingly installed in the card-reading socket on the same time.

2) Description of the Prior Art

To meet the diverse specification of memory cards, the card-reading interface needs connecting terminals with different specifications. The card-reader that accepts distinct cards is therefore introduced to solve the problem of memory cards with different specifications. To scale down the size of whole machine, this type of card-reader typically provides a cavity to be shared by two or more than two memory cards with different specifications.

To provide a cavity to be shared by multiple memory cards, the connecting terminals embedded in the cavity are usually allocated a layered structure. Apparently, the amounts and specifications of connecting terminals embedded into a card-reading socket thus become intricate. Therefore, for the manufacturers, the approach to install those minute and complicated connecting terminals inside a card-reading socket has become an important issue.

The improvement on connecting terminals of multi-specification card-reading socket presented in this invention mainly modualizes the connecting terminals. Through the structural design of modualization, the multiple connecting terminals are thus integrated into one, and with one-time processing, the complicate connecting terminals are accordingly installed in the card-reading socket on the same time. The assembly process and time are thus simplified, the failure rate as well as the cost during manufacturing process are accordingly decreased.

### SUMMARY OF THE INVENTION

The main purpose of the present invention is to provide connecting terminals that can be precisely and promptly assembled to a card-reading socket, where technology of structural design is provided to modualize terminals, the complicate connecting terminals therefore can be simultaneously installed in the card-reading socket within one-time processing.

The detailed descriptions as well as the technical contents of the present invention shall be given with the accompanying drawings hereunder.

### BRIEF DESCRIPTION OF THE DRAWINGS

FIG. 1A shows an elevational view of the raw material for connecting terminal module according to the present invention.

FIG. 1B shows an elevational view of the connecting terminal module according to the present invention.

FIG. 1C shows a side view of the connecting terminal module according to the present invention.

FIG. 2 is a pictorial drawing showing assembling connecting terminal module to a card-reading socket according to the present invention.

FIG. 3 is another pictorial drawing showing assembling connecting terminal module to a card-reading socket according to the present invention.

FIG. 4 is yet another pictorial drawing showing assembling connecting terminal module to a card-reading socket according to the present invention.

FIG. 5 is a further pictorial drawing showing assembling connecting terminal module to a card-reading socket according to the present invention.

FIG. 6 shows an elevational view after assembling connecting terminal module to a card-reading socket according to the present invention.

FIG. 7 shows an elevational drawing viewed from another viewpoint after assembling connecting terminal module to a card-reading socket according to the present invention.

### SYMBOL DESCRIPTION OF THE DRAWINGS

Raw material 1
Terminal module 10
Locating hole 101
Supporting plate 102
Grooves 103, 104
Supporting part 105
U-shaped slot 107
Connector 106
Connecting terminals 11
Card-reading socket 2
Side-wall 21
Embed-slot 210
Convex parts 211, 211′
Tool track 3
Convex part for locating 31

### DETAILED DESCRIPTION OF THE PREFERRED EMBODIMENTS

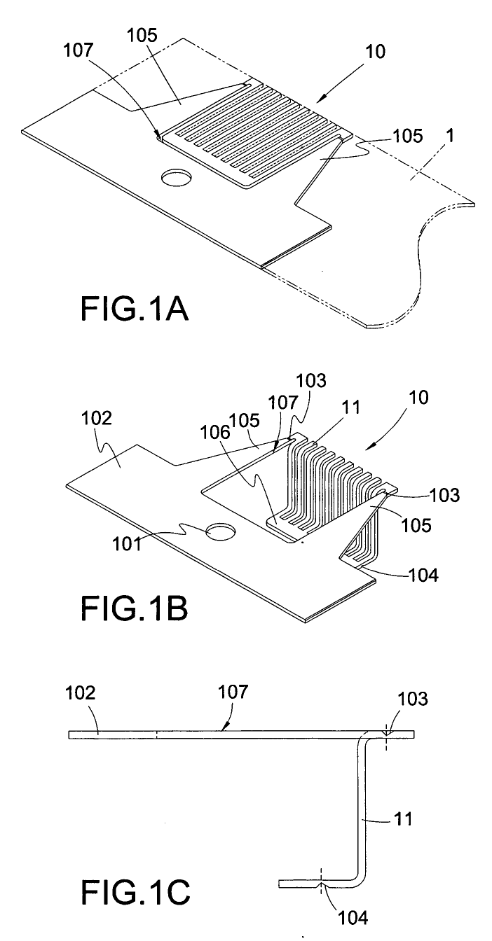

Referring to FIG. 1A to 1C, which show the forming process of connecting terminals according to the present invention, in which a terminal module 10 is formed from a raw material 1, where the said terminal module 10 includes multiple connecting terminals 11, and at both sides of multiple connecting terminals 11 supporting parts 102 are formed to connect to a supporting plate 102. The said supporting plate 102 provides a locating hole 101 at appropriate position to locate fed material during assembly. Around multiple connecting terminals 11 and two support parts 105 a U-shaped slot 107 is formed, and the ends of the said multiple connecting terminals are connected to a connector 106, where grooves 103, 104 are separately provided at the connecting regions between connecting terminals 11 and two supporting parts 105 as well as the connector 106, in which grooves 103, 104 are supplied as cutting portion after connecting terminals 11 are installed, such that multiple connecting terminals 11 can be simultaneously installed in the card-reading socket during one-time process.

The primary objective of the present invention is to integrate multiple connecting terminals into a terminal module 10. To achieve the objective, a flat plat is firstly stamped and bended to formed in a rough Z-shape, and then assembled to the card-reading socket. After assembly, the provided grooves 103, 104 are utilized to exclude all other parts except connecting terminals 11.

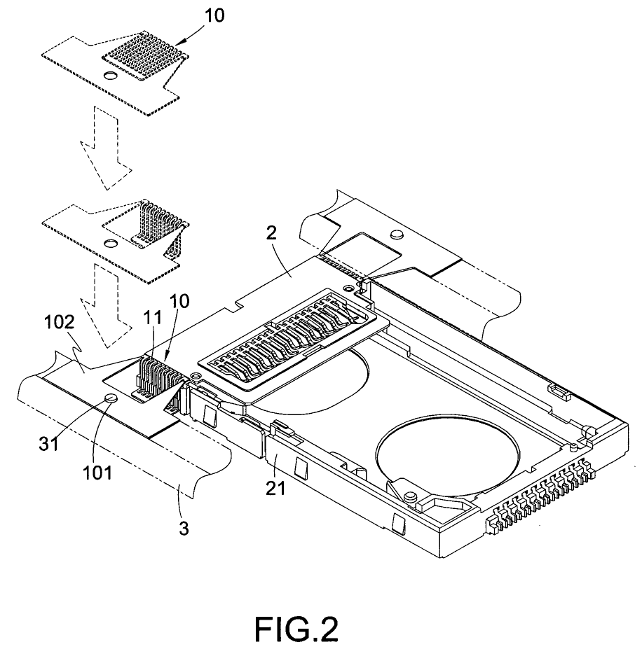

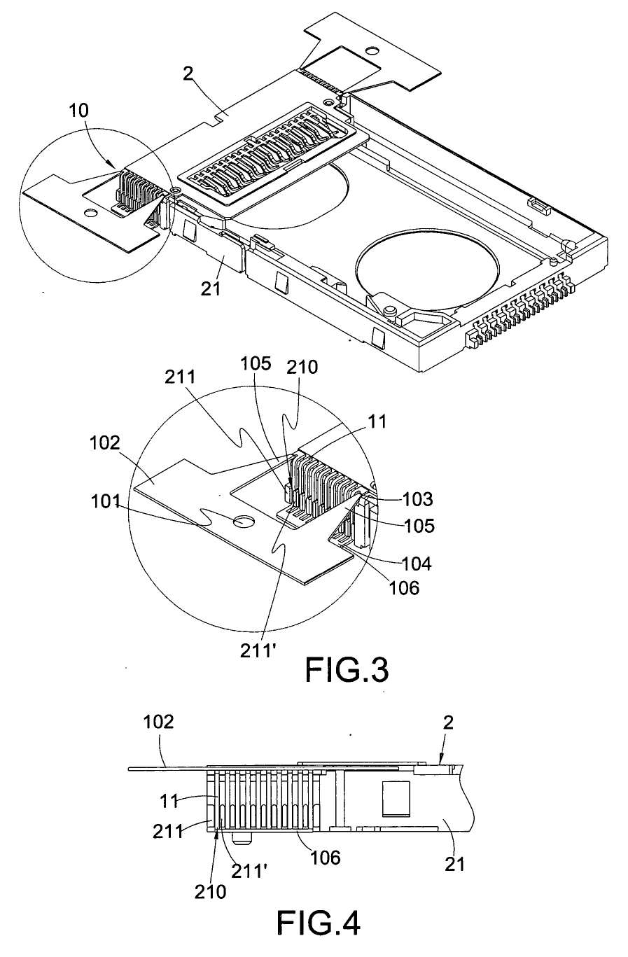

Further, referring to FIGS. 2 and 3, which are pictorial drawings showing the assembly according to the present invention. When terminal module 10 is assembled to the card-reading socket 2, a convex part for locating 31 on a tool track 3 is provided to correspond to locating hole 101 on the supporting plate 102 to facilitate locating. Situating the convex part for locating 31 exactly on the locating hole 101 ensures each pair of terminal module 10 corresponding to the card-reading socket 2, and each connecting terminal 11 thus corresponding to the embed-slot 210 on the sidewall 21 of card-reading socket 2, one by one. The said each embed-slot 210 is formed in between two corresponding convex parts 211, 211′, such that the connecting terminal 11 can be installed in the embed-slot 210, as shown in FIG. 4.

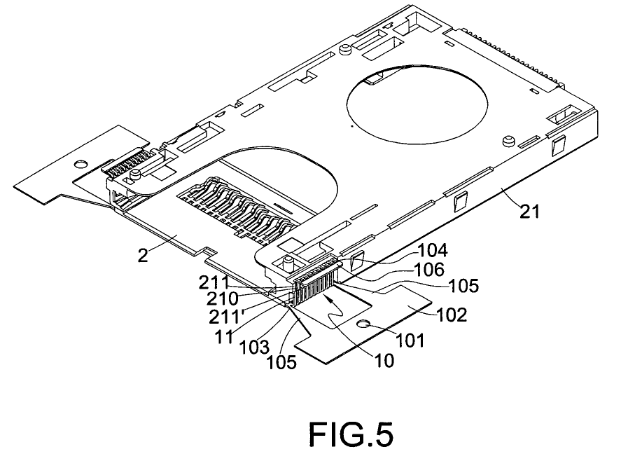

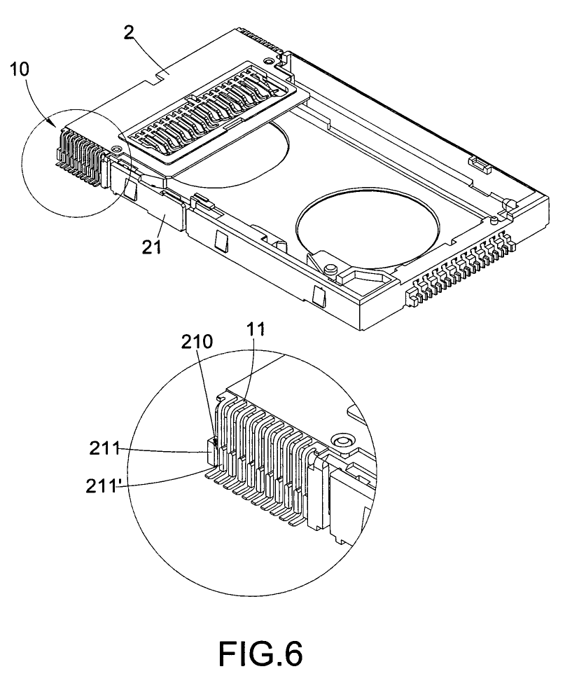

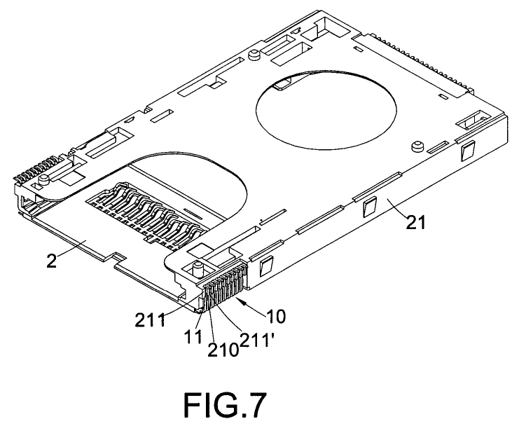

Following the installation of terminal module 10 in the card-reading socket, the operation of embedding each connecting terminal 111 into embed-slot 210 is demonstrated in FIG. 5, in which between the end of each connecting terminal 11 and connector 104 a groove 104 is provided. Cutting at the groove 104 can easily separate connector 106 from each connecting terminal 11. Further, grooves 103 are provided between two support parts 105 and connecting terminals 11, such that all parts except connecting terminals 11 are entirely separated. After cutting, each connecting terminal 11 is independently embedded in the embed-slot 210, as shown in FIGS. 6 and 7.

Consequently, the improvement on connecting terminals of multi-specification card-reading socket according to the present invention utilizes the structural design of modualizing connecting terminals, such that multiple connecting terminals are integrated into one, and thus only one-time embedding process is necessary to install multiple connecting terminals 11 in a card-reading socket 2. Therefore, the procedure and processing time for assembling connecting terminals 11 are simplified. Besides, the failure arte and cost for manufacturing process are decreased through structural design of modualization.

1-3. (canceled)

4. A terminal module for providing connecting terminals on a card-reading socket, comprising:
a set of multiple connecting terminals each having a forward end and a rear end;
a supporting plate disposed along a rear of said set of multiple connecting terminals;
a pair of support arms extending forward from said supporting plate and along respective opposite sides of said set of multiple connecting terminals, forward ends of the support arms each being connected to a forward part of said set of multiple connecting terminals;
wherein a U-shaped slot is defined around said set of multiple connecting terminals between said set of multiple connecting terminals and said supporting plate and said support arms;
such that said connecting terminals are configured to be formed and installed in said socket at the same time.

5. The terminal module according to claim 4, wherein the rear end of each of said connecting terminals is connected to a connector.

6. The terminal module according to claim 5, wherein a groove is formed where each of said connecting terminals is connected to said connector whereby said connecting terminals may be separated from said connector.

7. The terminal module according to claim 4, wherein a groove is formed where each of said support arms is joined to said set of multiple connecting terminals, whereby said set of multiple connecting terminals may be separated from said support arms.

8. The terminal module according to claim 4, wherein said set of multiple connecting terminals is configured to be bent and formed in a rough Z-shape to be embedded in said card-reading socket.

9. The terminal module according to claim 8, wherein said card-reading socket provides multiple convex parts with embed-slots separated by the width of a said connecting terminals for embedding said connecting terminals.
